(19) United States
(12) Patent Application Publication
(10) Pub. No.: US 2023/0150300 A1
(43) Pub. Date: May 18, 2023

(54) Wheel Assembly

(71) Applicant: Holley Performance Products, Inc., Bowling Green, KY (US)

(72) Inventor: Daniel Charles Finke, Austin, TX (US)

(21) Appl. No.: 18/054,805

(22) Filed: Nov. 11, 2022

Related U.S. Application Data
(60) Provisional application No. 63/278,954, filed on Nov. 12, 2021.

(51) Int. Cl. B60B 7/00; B60B 1/06; B60B 7/02; B60B 25/00

(52) U.S. Cl. CPC B60B 7/0066; B60B 1/06; B60B 7/02; B60B 25/002; B60B 2900/1216

(57) ABSTRACT

Present embodiments relate to a wheel assembly. More specifically, but without limitation, present embodiments relate to a wheel assembly having a wheel fairing which improves aerodynamic performance during operation without hindering the aesthetics of the vehicle wheel or preventing cooling of brake components.

### CLAIM TO PRIORITY

This non-provisional patent application claims priority to and benefit of, under 35 U.S.C. § 119(e), U.S. Provisional patent application Ser. No. 63/278,954, filed Nov. 12, 2021 and titled “Wheel Assembly”, all of which is incorporated by reference herein.

### BACKGROUND

### 1. Field of the Invention

Present embodiments relate to a wheel assembly. More specifically, but without limitation, present embodiments relate to a wheel assembly having a wheel fairing which improves aerodynamic performance during operation.

### 2. Description of the Related Art

Rotating wheels can have a negative impact on the aerodynamic performance of any vehicle. It is commonly accepted that up to 30% of total vehicle drag is caused by the wheels.

Air flowing down the sides of vehicles face turbulence created by the front and then rear wheels. Air flowing toward the wheel well meets the air impacted by the wheels during their rotational movement. The spokes of rotating wheels creates changes in air pressure, speed, and direction. When the air moving down the side of the vehicle meets this turbulent air, it separates from the vehicle's surface and starts to tumble. The wake created from the interaction of the differing air streams at the front wheel then meets the same condition created by the rear wheel.

This separation and tumbling inhibits the air moving down the sides of the vehicle from smoothly rejoining the air from above and below the vehicle. In turn, this erratic wake generates high levels of drag, reducing efficiency and range

Traditional wheel covers are not popular in passenger vehicles because they detract from the appearance of the vehicle and eliminate airflow that may be required for adequate brake cooling.

Consequently, there is a need for aerodynamic wheel enhancement that decreases drag and improves efficiency and range, without detracting from the vehicle's appearance and/or eliminating required air for cooling.

The information included in this Background section of the specification, including any references cited herein and any description or discussion thereof, is included for technical reference purposes only and is not to be regarded as subject matter by which the scope of the invention is to be bound.

### SUMMARY

The present application discloses one or more of the features recited in the appended claims and/or the following features which alone or in any combination, may comprise patentable subject matter.

The present embodiments provide wheel assemblies including a wheel fairing. The wheel fairing insert provides aerodynamic enhancement to the vehicle by improving airflow across the surface of the wheel which reduces turbulence and overall vehicle drag. The wheel fairing may cover spaces in the wheel between spokes and in some instances, members of spokes, reducing and inhibiting air in the wheel of the vehicle and thereby improving aerodynamic performance. The wheel fairing may be installed from behind the spokes and extends outwardly to the outer profile edge of the spokes, or just short of the outer profile edge. The wheel fairing also enhances the appearance of the wheel and vehicle, and allows for increased efficiency, range and brake component cooling.

According to some embodiments, a wheel assembly may comprises a wheel having, a first wheel lip, a second opposed wheel lip, a wheel barrel extending between the first wheel lip and the second opposed wheel lip, a plurality of spokes extending from a central hub bore to one of the wheel lips or the wheel barrel, a wheel fairing extending from an inward side of the plurality of spokes to a position flush with or short of an outward profile of the plurality of spokes.

According to some optional features, the following embodiments may be used alone with the wheel assembly or in combination with other features and the wheel assembly. Each of the plurality of spokes may be a single spoke. The wheel fairing may extend between adjacent spokes of the plurality of spokes. Each of the plurality of spokes may be a dual spoke structure. The wheel fairing may extend between adjacent spokes of the plurality of spokes and between each pair of members of the dual spoke structure. The wheel fairing may comprise a plurality of protrusions. The plurality of protrusions may be located between adjacent spokes of the plurality of spokes. The plurality of protrusions may be located between pair of members of dual spokes. The wheel fairing may having an interreference fit with, or fastening apertures for connection with, the plurality of spokes. The wheel fairing may have an outward profile. The outward profile may be linear from a central location in a radial direction. The outward profile may be curved, or a combination of linear and curved, from a central location in a radial direction. The wheel assembly may further comprise a gap disposed between a peripheral edge of the wheel fairing and the wheel barrel or one of the wheel lips. The wheel may being a one-piece wheel or the wheel assembly may be a multi-piece wheel.

According to some embodiments, a wheel fairing may comprise a base circular base having an inner perimeter opening and an outer peripheral edge, a plurality of protrusions extending from the base, the plurality of protrusions being of one or more shapes and one or more heights from the base, a plurality of spoke channels disposed between adjacent pairs of the plurality of protrusions, one or more fastener apertures capable of alignment with apertures on a wheel for connection of the wheel fairing.

According to some optional features, the following embodiments may be used alone with the wheel fairing or in combination with other features and the wheel fairing. The wheel fairing may further comprise a radially outer surface extending between a wheel fairing outer profile surface and a peripheral edge, the radially outer surface being beveled, radiused, or perpendicular to the wheel fairing outer profile surface. The wheel fairing may further comprise an outer profile surface which is linear, or curved, or a combination of linear and curved.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the various embodiments may be gleaned from the disclosure herein. Therefore, no limiting interpretation of this summary is to be understood without further reading of the entire specification, claims and drawings, included herewith. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

In order that the embodiments may be better understood, embodiments of a wheel assembly will now be described by way of examples. These embodiments are not to limit the scope of the claims as other embodiments of a wheel assembly will become apparent to one having ordinary skill in the art upon reading the instant description. Non-limiting examples of the present embodiments are shown in figures wherein:

FIG. 1 is a perspective view of a wheel assembly;

FIG. 2 is a perspective view of a wheel fairing of the wheel assembly;

FIG. 3 is a perspective view of an opposite side of the wheel fairing of FIG. 2;

FIG. 4 is a side section view of the wheel assembly of FIG. 1;

FIG. 5 is an alternate side section view of the wheel assembly of FIG. 1;

FIG. 6 is a perspective view of a second wheel assembly embodiment;

FIG. 7 is a perspective view of an alternate embodiment of a wheel fairing; and,

FIG. 8 is an exploded perspective view of an alternate multi-piece wheel.

### DETAILED DESCRIPTION

It is to be understood that a wheel assembly is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

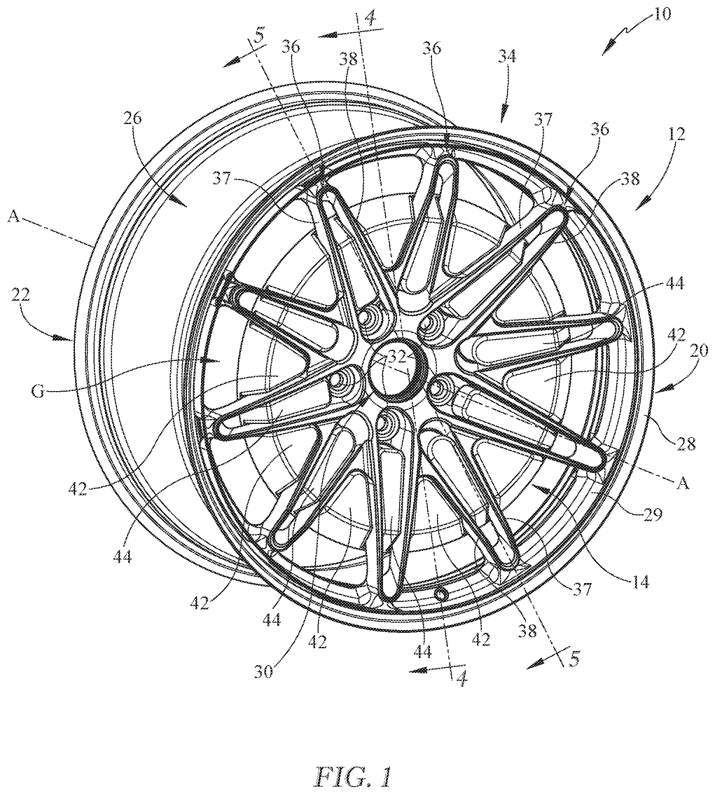

Referring now to FIGS. 1-8, various embodiments of a wheel assembly are depicted. The wheel assembly reduces aero-tumbling, or rotary motion, of airflow within a wheel barrel while still allowing for brake cooling. A wheel fairing is disposed within the barrel from behind the wheel spokes and extending toward an outer edge profile of the spokes. This rear mounting provides improved aesthetics for the wheel while still allowing for improved aero-performance of a vehicle.

Referring now to FIG. 1, a perspective view of a wheel assembly 10 is depicted. The wheel assembly 10 includes a wheel 12 and a wheel fairing 14. The wheel 12 comprises an outer or front lip 20, a barrel 26 extending rearwardly from the front lip 20 and an inner or rear lip 22. As related to the lips 20, 22, the terms outer and inner refer to the outward facing (outer) and inward facing (inner) edges of the wheel 12. The wheel 12 has a central axis A about which the wheel 12 rotates. The lips 20, 22 may have a first surface 28 and a second surface 29 which is at an angle to the first surface. In the depicted example the first and second surfaces 28, 29 are generally about perpendicular to one another wherein the second surface 29 extends in an axial direction from the barrel 26 and the first lip surface 28 extends radially from the barrel 26 or the second lip surface 29. In some embodiments the lip 20 may be defined by a single surface that extends from the barrel 26 and an angle to the surfaces of the barrel 26, for example in a radial direction from the barrel 26.

The center of the wheel 12 comprises a hub bore 30 having a plurality of lug holes 32 disposed about the center hub bore 30. The axis A of the wheel 12 extends through the hub bore 30 of the wheel 12. The barrel 26 may be cylindrical in shape and may have a profile with a constant diameter or a varying diameter, along the axial direction, between the outer lip 20 and the inner lip 22.

Extending from the hub bore 30 are a plurality of spokes 34. The plurality of spokes 34 comprise individual spokes 36 that extend radially outward from the hub bore 30 to either or both of the barrel 26 or the outer lip 20. Each spoke 36 of the plurality of spokes 36 may comprise a single member or a plurality of members 37, 38. For example, in the embodiment of FIG. 1, the wheel 12 comprises spokes 36 that extend from the hub 30 and toward the first lip 20, where they join at a U-shaped structure. The members 37, 38 of each spoke 36 may be parallel or may be slightly angled, toward or away from one another at radially outward ends.

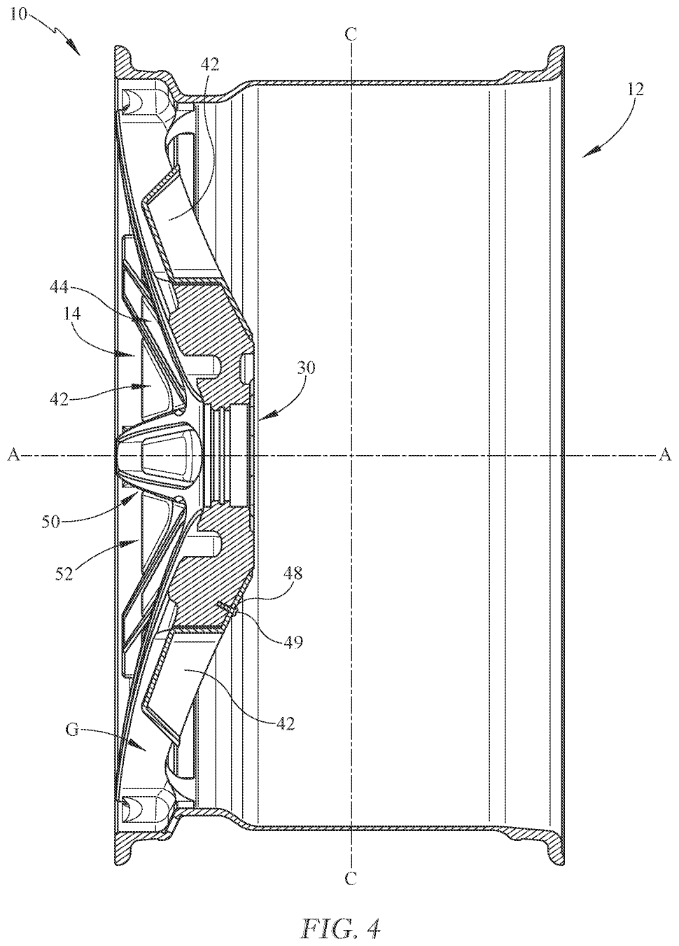

Additionally, the spokes 36 may extend in a purely radial direction from the hub bore 30, or may extend radially and at an angle from the outer surface of the hub bore 30. When viewed in the section view of FIG. 4, for example, the spokes 36 may vary through a vertical plane that is perpendicular to the axis A. The angle and shape of the spokes 36 and amount of variation through the vertical plane may depend on the wheel offset, which generally relates the mounting or inner surface of the hub bore 30, to the outer surface of the wheel to the centerline of a wheel barrel, while maintaining clearance relative to a brake assembly.

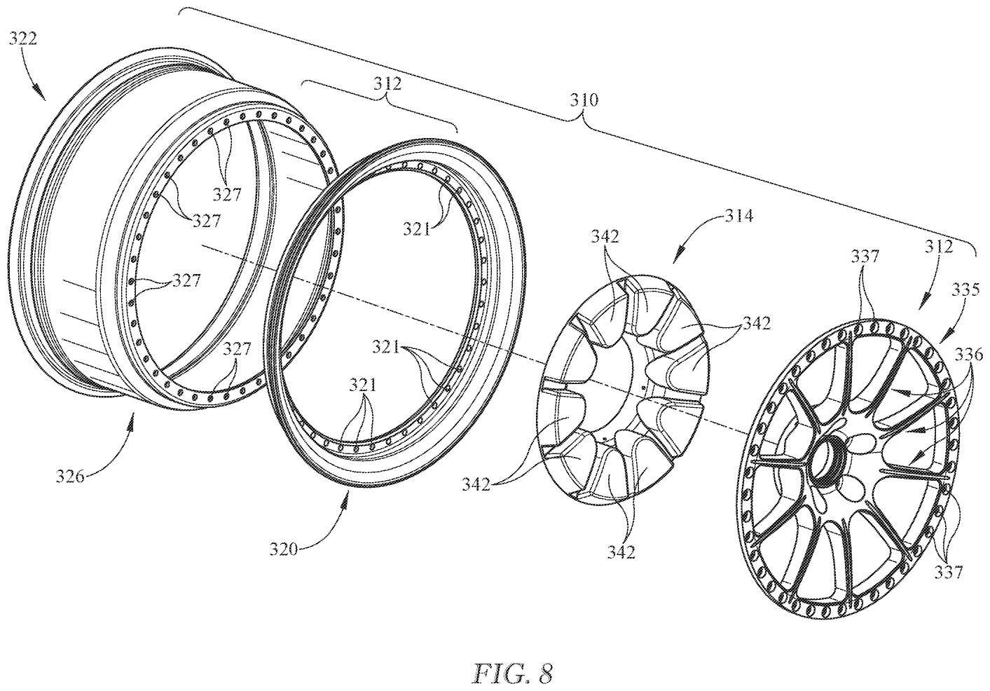

The wheel 12 may be a single piece structure as shown. In other embodiments, such as shown in FIG. 8, the wheel 12 may be a multi-piece structure.

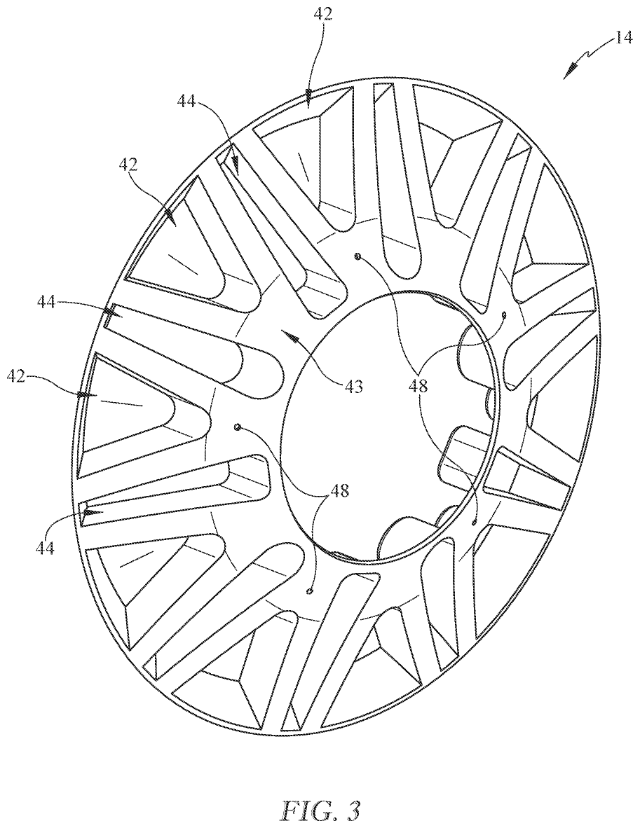

Also shown in FIG. 1, the wheel assembly 10 comprises the wheel fairing 14. The wheel fairing 14 inhibits some air from entry and allows some air to exit the barrel 26 of the wheel during rotation. The reduction of aero-tumbling improves aerodynamic performance of the wheel assembly 10. The wheel fairing 14 is generally circular in shape having a base 40 and a plurality of protrusions 42, 44. The base 40 has an outer surface 41 and an inner surface 43 (FIG. 3). The protrusions 42, 44 extend from the base 40 in an axially outward direction toward an outer profile edge of the spokes 36. The base 40 is shown circular in shape and may include a peripheral edge which is perpendicular to the outer and inner surfaces 41, 43 or which may be tapered, radiused, or otherwise non-perpendicular.

The protrusions 42 extend between the adjacent spokes 36 of the plurality of spokes 34. Additionally, in some embodiments, where each spoke 36 is defined by two or more members 37, 38, the protrusions 44 may be located between the members 37, 38 of each spoke 36.

The wheel fairing 14 is disposed behind, on the inner side, of the spokes 36 such that the protrusions 42, 44 extend toward the outer profile edge of the spokes 36.

The wheel fairing 14 is circular in shape having a diameter that is less than the diameter of the barrel 26. The fairing 14 may extend radially outwardly at least about 50 percent of the radius of the wheel 12. More specifically, the fairing 14 may extend radially outwardly up to about 85 percent of the radius of the wheel 12. A gap G is defined between a peripheral edge of the wheel fairing 14 and the barrel 26 or lip 20. The gap G allows for airflow over the brakes, for cooling. However, the wheel fairing 14 also reduces airflow within the barrel 26 which results in tumbling and rotational air pattern that is not efficient.

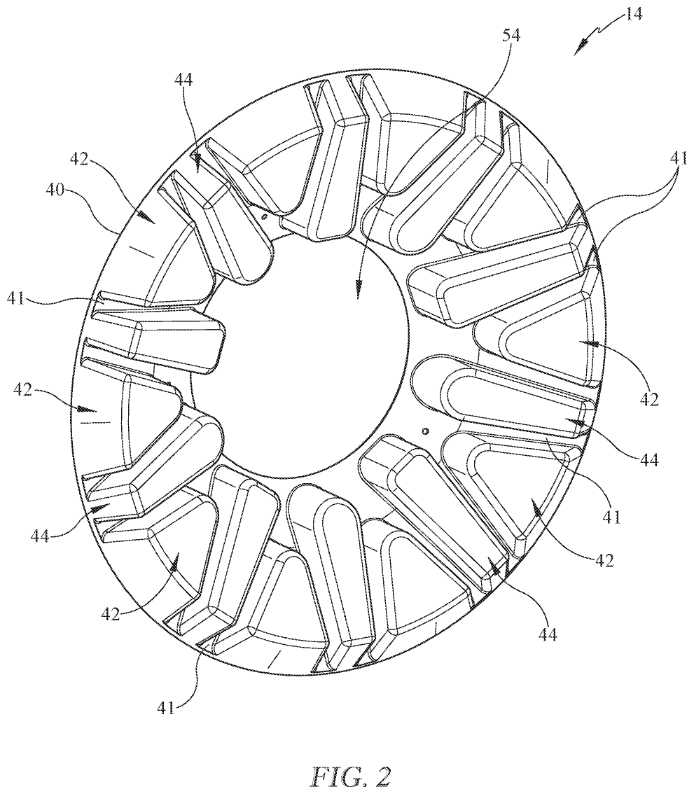

Referring now to FIG. 2, a perspective view of the wheel fairing 14 is shown removed from the wheel 12. In this view, the circular shape of the fairing is clearly shown. A void 54 is formed in the center of the wheel fairing 14 in through which wheel lugs (not shown) pass to engage the wheel 12. The wheel fairing 14 may be formed of various lightweight, high strength materials. In some embodiments, the part may be a molded plastic. In other embodiments, the wheel fairing 14 may be formed of carbon fiber. These are merely examples and other materials may be utilized.

The protrusions 42, 44 may have various shapes depending on the pattern of the spokes 36. Likewise, the spacing between the protrusions 42, 44 also depends on the spoke 36 pattern. The fairing 14 is located on the inside of the spokes 36 and the protrusions 42, 44 have a dimension measured from the base 40 to the outer surface of the protrusions 42, 44. The dimension may be a height dimension if the fairing 14 is laid flat, for example. The height may be consistent or the height may vary depending on an outer profile of the spokes 36. In the embodiments, the protrusions may extend up to the outer profile edge of the spokes. In some other embodiments the protrusions 42, 44 may extend outward but short of the outer profile edge of the spokes 36.

With this in mind, the outer profile of the wheel fairing 14 may be flat, or may be convex, or may be concave, or some combination. In some embodiments, the wheel fairing 14 may have variations of these shapes along a radial dimension.

The wheel fairing 14 may be connected to the wheel in a variety of ways. In some embodiments, the wheel fairing 14 may be interference fit with the wheel 12, for example the spokes 36. In other embodiments, the wheel fairing 14 may be fastened to the wheel. For example, the wheel fairing 14 may have a plurality of fastener holes 48. The fastener holes 48 may receive a fastener from the inner side of the wheel fairing 14 and extending to the inner or rear side of the wheel 12. In some embodiments, combinations of connections may be utilized.

Referring now to FIG. 3, a rear side of the wheel fairing is depicted in perspective view. In this view, the protrusions 42, 44 are depicted extending from the inner (inward) surface 43 of the base 40. The view also depicts differences in the protrusions 42, 44. In this view, the protrusions form depressions in the inner (rear) side 43 of the wheel fairing 14. The radially longer protrusions 44 are protrusions that fit between members 37, 38 of a spoke 36. Alternately, the radially shorter protrusions 44 are those that fit between adjacent spokes 36. These protrusions 42, 44 may have an interference fit with the spokes 36.

The protrusions 42, 44 may be hollow recesses when viewed from behind. The protrusions 42, 44 may extend from the rear surface 43 of base 40 through the front of the wheel fairing 14. The protrusions 42, 44 are shown with a repeating pattern of shapes. The repeating pattern corresponds to the shapes that fit between adjacent spokes and, in the instant embodiment, between pairs of members of a single spoke.

Also shown in this view are the fastener apertures 48 which extend through the wheel fairing 14. The fastener apertures 48 are disposed near the inner perimeter about the void. The apertures 48 may be formed in thickened areas of the fairing wheel 14, closer to the hub bore 30, for improved strength. The fastener aperture 48 receives a fastener 49 for connection to the wheel 12.

Referring now to FIG. 4, a side section view of the wheel assembly 10 is shown. The section view depicts a profile, or profile edge, 50 of the spokes 36 relative to the remainder of the wheel 12. From this view, the profile edge 50 may be linear, curved, or a combination of curved and linear. In the depicted embodiment, the hub bore 30 is positioned inward of the lip 20, and the spokes 36 extend outward with both curved and linear portions toward the lip. Additionally, the protrusions 42, 44 may have a profile 52 that that is linear or curved and may, or may not, match the contour of the spokes 36.

Also shown in this view, the spokes 36 may be angled relative to the outer surface of hub bore 30. The angle may be dependent on the width of the barrel 26 in the axial (axis A) direction, the location of the hub bore mounting surface relative to a barrel center line—also referred to as offset—and other factors such as number, shape, and size of the spokes 36.

Additionally, the wheel fairing 14 is shown on the inner side of the spokes 36. The sum of the protrusions 42, 44 and base 40 thickness or depth dimensions may provide that the outer profile edge 50 of the wheel fairing 14 is even with or just short of the outer profile edge 50 of the spokes 36. However, the diameter difference between the wheel fairing and the wheel stills allows for airflow to enter the barrel and cool the brakes. The protrusions 42, 44 may extend between adjacent spokes 36 and adjacent members 37, 38 of a single spoke to the outer profile edge 50 of the spokes 36.

Further, a fastener 49 is shown in the section view that depicts a connection between the wheel fairing and the wheel. The fastener 49 is shown extending through the fairing and into the wheel. In this way the fastener 49 retains the wheel fairing to the wheel.

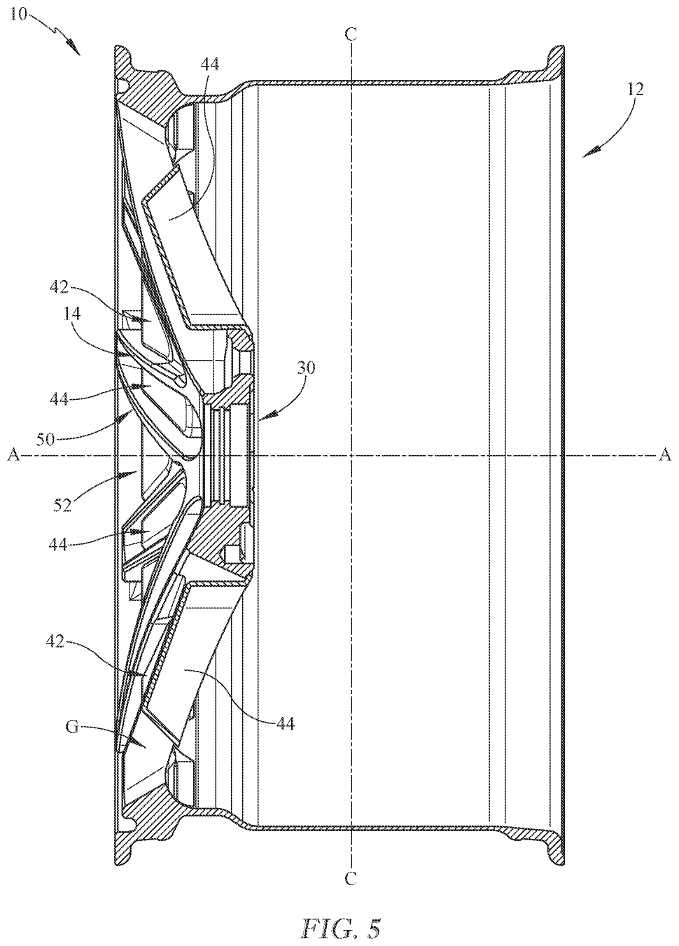

Referring now to FIG. 5, a section view is taken along a different section line than FIG. 4. The section view of FIG. 5 shows a difference in the positioning of the protrusions 42 relative to the spokes 36. In some embodiments, the protrusions 42, 44 may be generally flush with the outer profile edge of the spokes, or the protrusions may be offset from the outer profile edge 50, or some combination. The section view of FIG. 5, a spoke 36 is shown below the axis A-A. The outer profile surface of the protrusion 44 is shown generally flush with spoke. This may be contrasted with the spoke 36 above, which shows an offset between the outer profile edge of the spoke 36 and the outer profile surface of protrusion 44. The outer surface profile of the one or more protrusions of a wheel fairing 14 may be flush with an outer profile edge or surface of a spoke 36, or may be flush or with an inner profile edge or surface of a spoke, or may be located at some point between the inner and outer edges of the spokes 34 (FIG. 1).

With additional brief reference to FIG. 1, some of the spokes 36 encompass the lug holes 32. These spokes 36 show the protrusions 44 are offset from the outer edge profile. Alternately, the spokes 36 located between lug holes, and which do not encompass the lug holes 32, have protrusions therein which are generally flush with the outer profile edge 50. As shown in FIG. 5, the section cut clearly shows that the protrusions are nearly flush with the spokes 36. The protrusions of the instant embodiments may be located in various locations relative to a vertical plane through the wheel parallel to C-C. The protrusions may have an outer profile at the inner edge of the spokes 36, or at the outer profile edge of the spokes 36, or some plane between. Likewise, the multiple protrusions may have some protrusions in one location relative to the outer/inner profile edge of the spokes and some protrusions in a second location relative to the outer/inner profile edge of the spokes, as within the scope of this teaching.

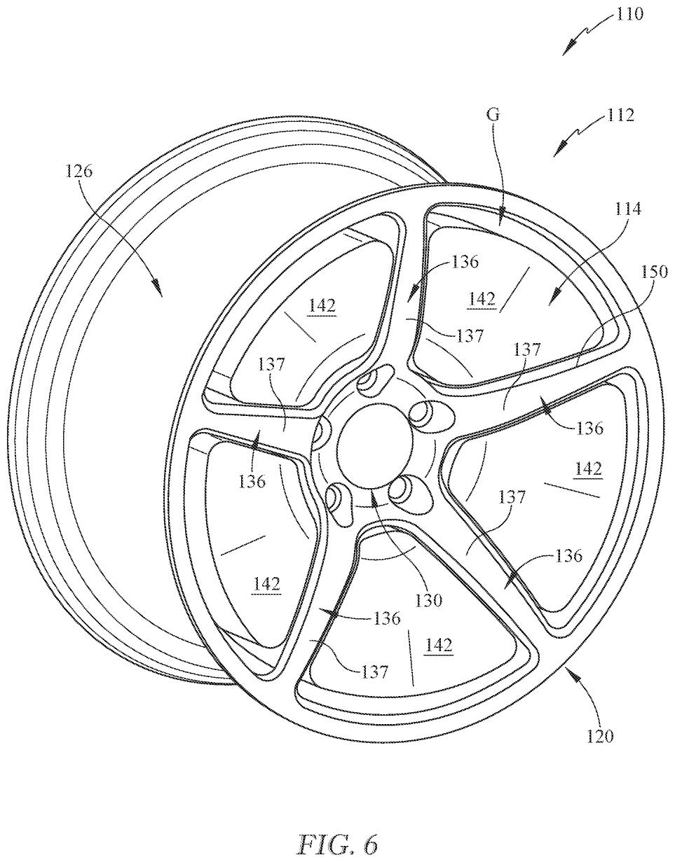

Referring now to FIG. 6, a second embodiment of a wheel assembly 110 is depicted. The wheel assembly 110 comprises a wheel 112 and a wheel fairing 114. The wheel 112 comprises five spokes 136. As opposed to the previous wheel embodiment, the spokes 136 of the instant wheel 110 are defined by single members 137. As a result there are five protrusions 142 located between adjacent spokes 136 but no protrusions between dual members of a single spoke as in the previous embodiment. The wheel fairing 114 may be mounted from the rear of the wheel 112 and as in the previous embodiment, the wheel fairing 114 may have an interference fit, utilize a fastener, a combination, or other means of connection.

In this embodiment, each of the protrusions 142 is generally frusto-triangular in shape. Additionally, the hub bore 130 is offset from the lip 120 so that the spokes 136 may be at an angle to the vertical as they extend radially outwardly. Further, as in previous embodiments, the spokes 136 may also be curved, linear, or a combination thereof. Likewise, the outer face of the wheel fairing 114, and for example the protrusions 142, may also be curved, linear, or a combination thereof. A gap G is also shown between the perimeter of the wheel fairing 114 and the radially inner surface of the wheel barrel 126. As previously described, the gap G allows some airflow into the wheel for example, for cooling of brakes.

Still further, the wheel fairing 114 may have a thickness such that the surface of the protrusions 142 either extend to the outer profile edge 150 of the spokes 136, or extend from behind to a position short of the profile edge 150.

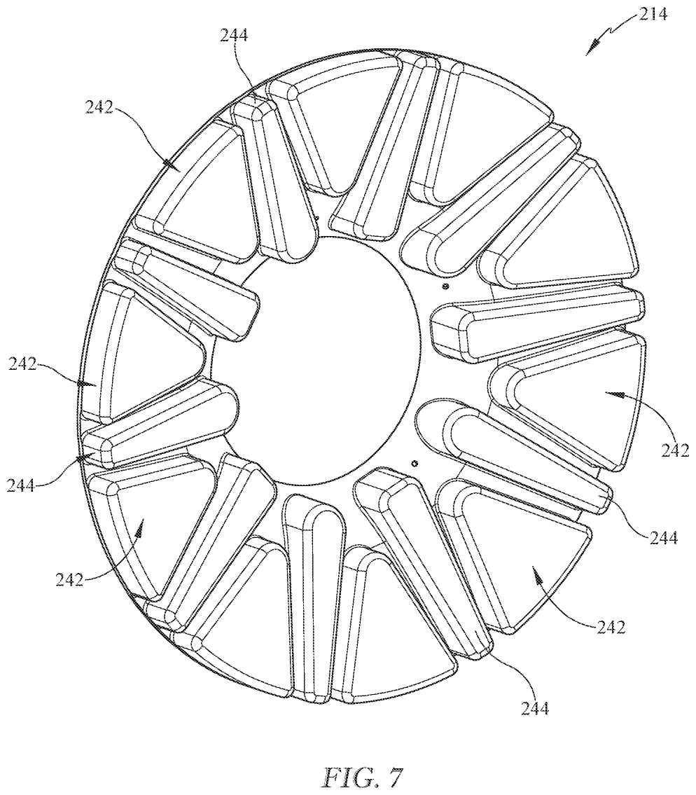

Referring now to FIG. 7, a further embodiment is provided. In this embodiment, the outer peripheral edge of the wheel fairing 214 is shown as closer to perpendicular to radially outer ends of the protrusions 242, 244, rather than beveled as in the previous embodiments. As with the previous embodiment, the one or more protrusions may be of one or more sizes. Likewise, the protrusions 242, 244 may have differing outer profile locations relative to the outer or inner spoke profile edges.

With reference now to FIG. 8, a wheel assembly 310 is shown in an exploded perspective view. The assembly 310 again includes a wheel 312 which is shown in multiple pieces, and a wheel fairing 314. As with previous embodiments, the protrusions 342 of the wheel fairing 314 may take various shapes dependent upon the pattern of spokes 336.

The wheel 312 includes an inner (rear) lip 322, a barrel 326, and an outer (front) lip 320, which is separated from the barrel 326 and inner lip 322. The outer lip 320 may include a flange with a plurality of fastener apertures 321 and likewise, the barrel 326 may include corresponding fastener apertures 327. Fasteners (not shown) may be used to connect the outer lip 320 and the barrel 326. A spoke portion 335 is also shown spaced from the outer lip 320. The spoke portion 335 may also have a flange with a plurality of fastener apertures 337 that correspond to those in the outer lip 320 and the barrel 326. As a result, the fasteners hold all parts of the multi-piece wheel 312.

The fairing 314 is positioned on the axially inner (rear) side of the spokes 336. The wheel fairing has a plurality of protrusions 342 which are disposed between the spokes 336, from behind. The wheel fairing 314 has an outer perimeter which may be beveled, perpendicular, or radiused from the outer profile surface of the protrusions 342, to the outer most edge. With the wheel fairing 314 mounted from behind, and the protrusions 342 extending between the spokes 336, outer profile surface of the protrusions 342 will be located between the at the inner edge of the spokes 336, at the outer edge of the spokes 336, or at some location between. The outer profile surface may be linear, curved, or some combination. As with previous embodiments, a fastener may be used to connect the wheel fairing 314 to the wheel 312, for example the spoke portion 335.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A wheel assembly, comprising:
a wheel having:
a first wheel lip;
a second opposed wheel lip;
a wheel barrel extending between the first wheel lip and the second opposed wheel lip;
a plurality of spokes extending from a central hub bore to one of said wheel lips or said wheel barrel;
a wheel fairing extending from an inward side of said plurality of spokes to a position flush with or short of an outward profile of said plurality of spokes.

2. The wheel assembly of claim 1 wherein each of said plurality of spokes is a single spoke.

3. The wheel assembly of claim 1, wherein said wheel fairing extends between adjacent spokes of said plurality of spokes.

4. The wheel assembly of claim 1 wherein each of said plurality of spokes is a dual spoke structure.

5. The wheel assembly of claim 4 wherein said wheel fairing extends between adjacent spokes of said plurality of spokes and between each pair of members of said dual spoke structure.

6. The wheel assembly of claim 1, said wheel fairing comprising a plurality of protrusions.

7. The wheel assembly of claim 6, said plurality of protrusions being respectively located between adjacent spokes of said plurality of spokes.

8. The wheel assembly of claim 7, said plurality of protrusions being respectively located between pairs of members of each spoke of said plurality of spokes.

9. The wheel assembly of claim 1, said wheel fairing having an interreference fit with, or fastening apertures for connection with, said plurality of spokes.

10. The wheel assembly of claim 1, said wheel fairing having an outward profile.

11. The wheel assembly of claim 1, said outward profile being linear from a central location in a radial direction.

12. The wheel assembly of claim 1, said outward profile being curved or a combination of linear and curved from a central location in a radial direction.

13. The wheel assembly of claim 1, further comprising a gap disposed between a peripheral edge of said wheel fairing and said wheel barrel or one of said wheel lips.

14. The wheel assembly of claim 1, said wheel being a one-piece wheel.

15. The wheel assembly of claim 1, said wheel being a multi-piece wheel.

16. A wheel fairing, comprising:
a base having an inner perimeter opening and an outer peripheral edge;
a plurality of protrusions extending from said base;
said plurality of protrusions being of one or more shapes and one or more heights from said base;
a plurality of spoke channels disposed between adjacent pairs of said plurality of protrusions;
one or more fastener apertures capable of alignment with apertures on a wheel for connection of said wheel fairing.

17. The wheel fairing of claim 16, further comprising a radially outer surface extending between a wheel fairing outer profile surface and a peripheral edge, said radially outer surface being beveled, radiused, or perpendicular to said wheel fairing outer profile surface.

18. The wheel fairing of claim 16, further comprising an outer profile surface which is linear, or curved, or a combination of linear and curved.
